(19) United States
(12) Patent Application Publication
(10) Pub. No.: US 2026/0292532 A1
(43) Pub. Date: Sep. 24, 2026

(54) GENERAL BEAM REPORT FORMAT FOR AI/ML BASED BEAM MANAGEMENT

(71) Applicant: MEDIATEK INC., Hsinchu City (TW)

(72) Inventors: Yu-Jen KU, San Jose, CA (US); Gyu Bum KYUNG, San Jose, CA (US)

(73) Assignee: MEDIATEK INC., Hsinchu City (TW)

(21) Appl. No.: 19/472,810

(22) PCT Filed: Jul. 22, 2024
(86) PCT No.: PCT/CN2024/106713

§ 371 Date: Oct. 6, 2025

Related U.S. Application Data
(60) Provisional application No. 63/516,563, filed on Jul. 31, 2023.

(51) Int. Cl. H04W 16/28; H04B 17/318; H04W 24/10

(52) U.S. Cl. CPC H04W 16/28; H04B 17/328; H04W 24/10

(57) ABSTRACT

In an aspect of the disclosure, a method, a computer-readable medium, and an apparatus are provided. The apparatus may be a UE. The UE receives a report configuration from a base station. The UE identifies a subset of beams from a beam set that meet a predetermined performance metric. The UE reports, based on the report configuration, a base main set of the subset and an indicator indicative of an attribute value of the base main set along with the reporting of the base main set. The UE reports an additional set of the subset.

### CROSS-REFERENCE TO RELATED APPLICATION(S)

This application claims the benefits of U.S. Provisional Application Ser. No. 63/516,563, entitled “METHOD AND APPARATUS OF GENERAL BEAM REPORT FORMAT FOR AI/ML-BASED BEAM MANAGEMENT” and filed on Jul. 31, 2023, which is expressly incorporated by reference herein in its entirety.

### BACKGROUND

### Field

The present disclosure relates generally to wireless communications, and more particularly, to techniques of beam reporting for artificial intelligence/machine learning (AI/ML) based beam management in wireless communication systems.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives a report configuration from a base station. The UE identifies a subset of beams from a beam set that meet a predetermined performance metric. The UE reports, based on the report configuration, a base main set of the subset and an indicator indicative of an attribute value of the base main set along with the reporting of the base main set. The UE reports an additional set of the subset.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7(A) is a diagram illustrating an AI/ML (artificial intelligence/machine learning) model for spatial and temporal domain beam prediction.

FIG. 7(B) is a diagram illustrating the temporal aspects of beam measurement and prediction in AI/ML-based beam management.

FIG. 8(A) is a flow chart of a process for beam reporting.

FIG. 8(B) is a flow chart of another process for beam reporting.

FIG. 9(A) is a diagram illustrating an example of separating a beam report into multiple parts.

FIG. 9(B) is a diagram illustrating an example of reporting indicators along with a base main set and additional sets.

FIG. 9(C) is a diagram illustrating an example of reporting time information along with the base main set and additional sets.

FIG. 9(D) is a diagram illustrating an example of using K bits to indicate the existence of the next part.

FIG. 9(E) is a diagram illustrating an example of using K bits to indicate the length of the next part.

FIG. 9(F) is a diagram illustrating an example of using K bits to indicate the length of the next part with a shorter Part 1.

FIG. 9(G) is a diagram illustrating an example of reporting temporal information along with the base main set and additional sets.

FIG. 9(H) is a diagram illustrating an example of reporting multiple temporal information in one beam report.

FIG. 9(I) is a diagram illustrating an example of reporting multiple temporal information in one beam report with differential RSRP.

FIG. 9(J) is a diagram illustrating an example of reporting multiple temporal information and variable beam numbers in one beam report.

FIG. 9(K) is a diagram illustrating an example of reporting multiple temporal information and variable beam numbers in one beam report with simplified temporal information.

FIG. 9(L) is a diagram illustrating an example of reporting multiple temporal information and variable beam numbers in one beam report using a two-part structure for each time instance.

FIG. 9(M) is a diagram illustrating an example of reporting absolute time for each part in a beam report.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

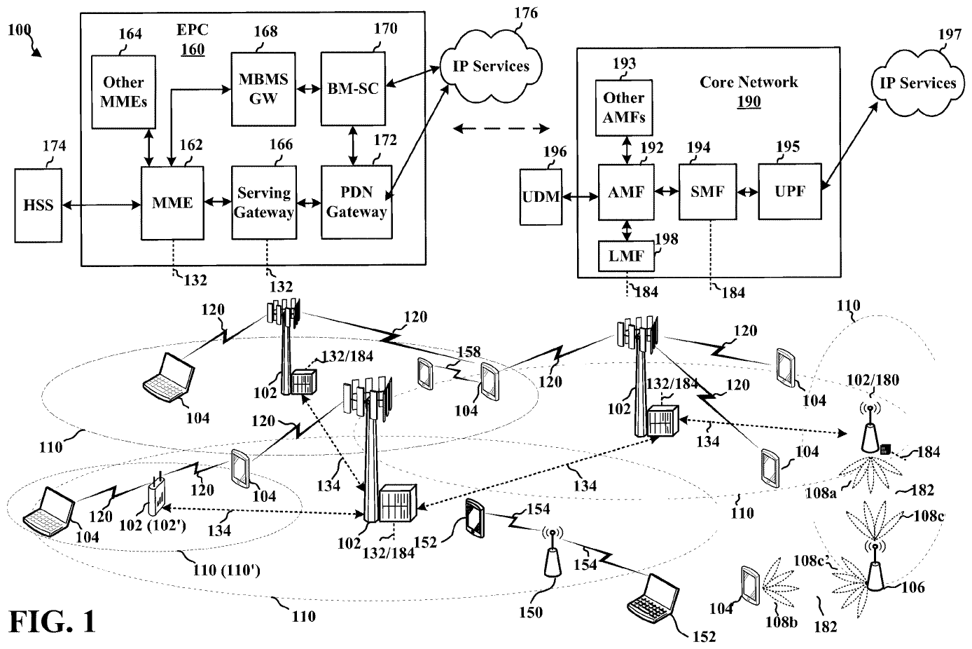

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links maybe through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

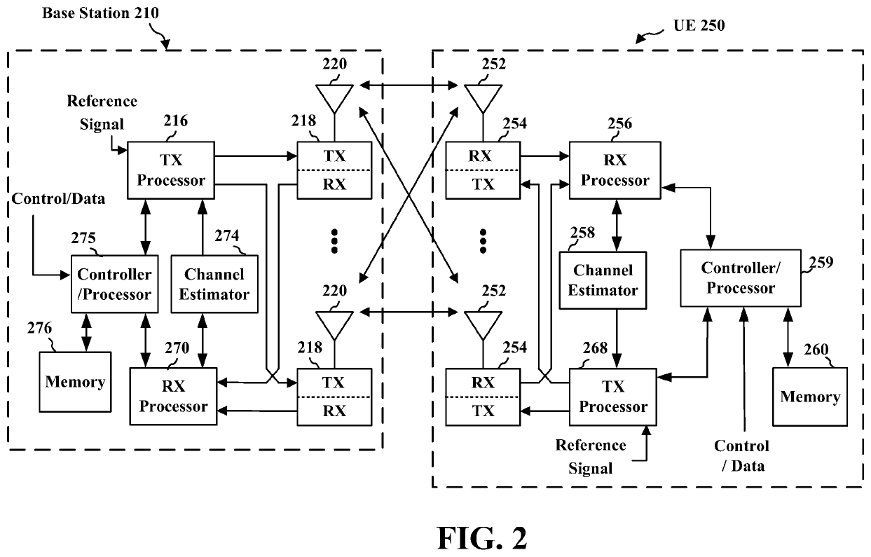

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

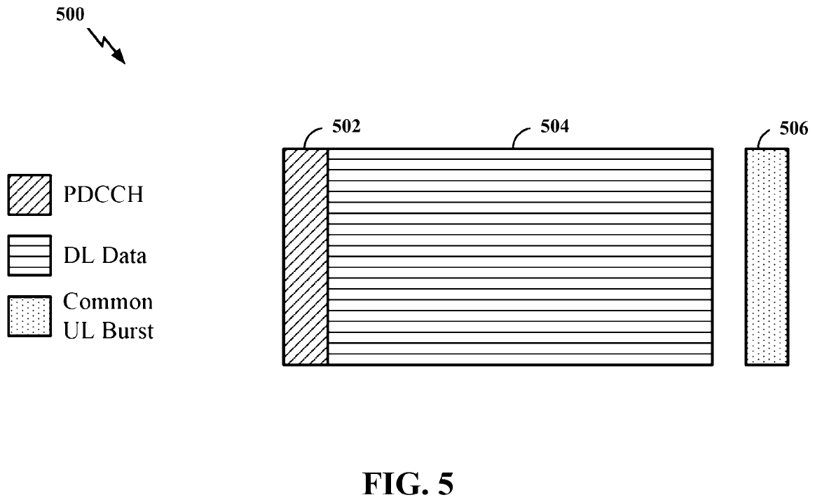

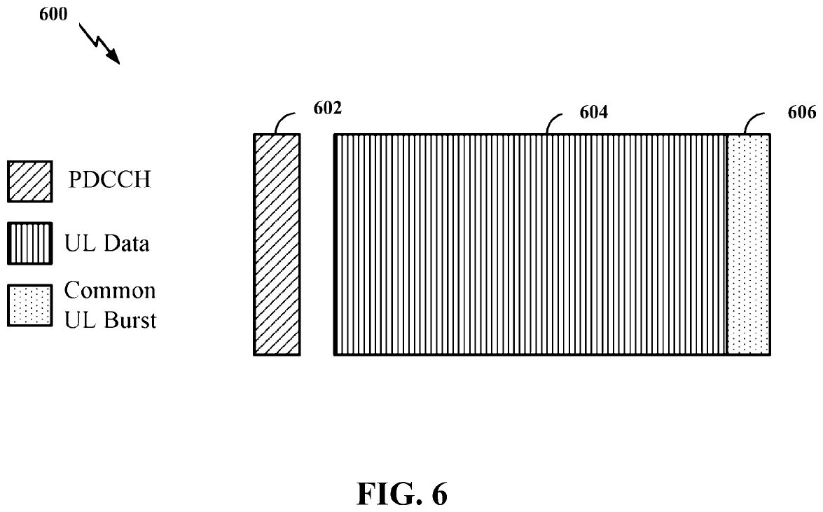

A single component carrier bandwidth of 100 MHz maybe supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

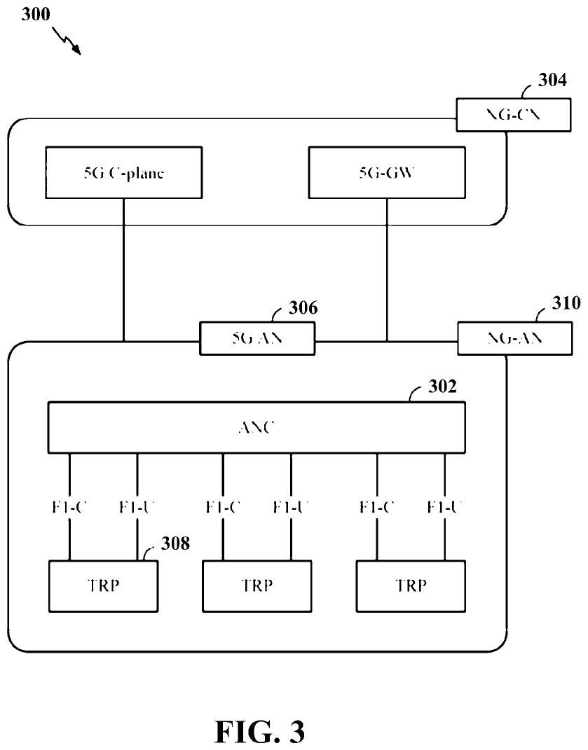

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

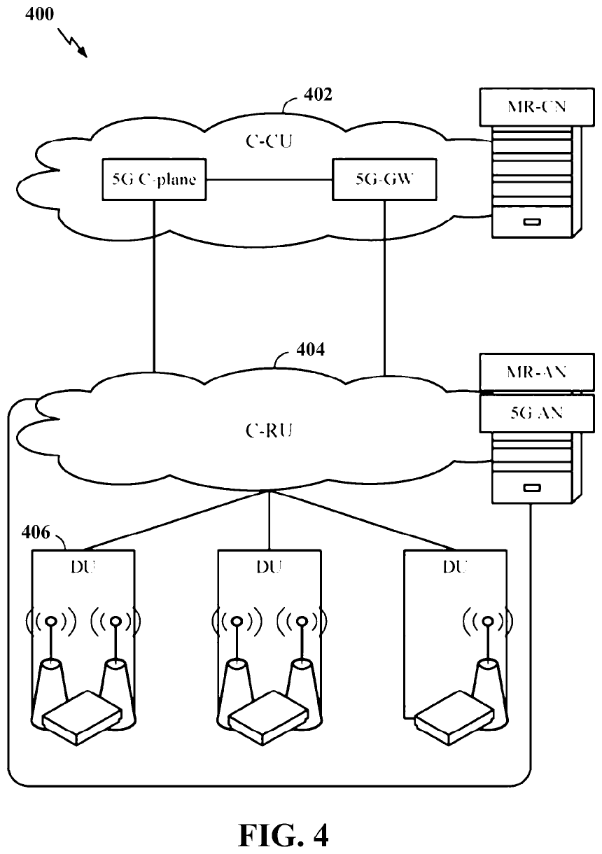

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

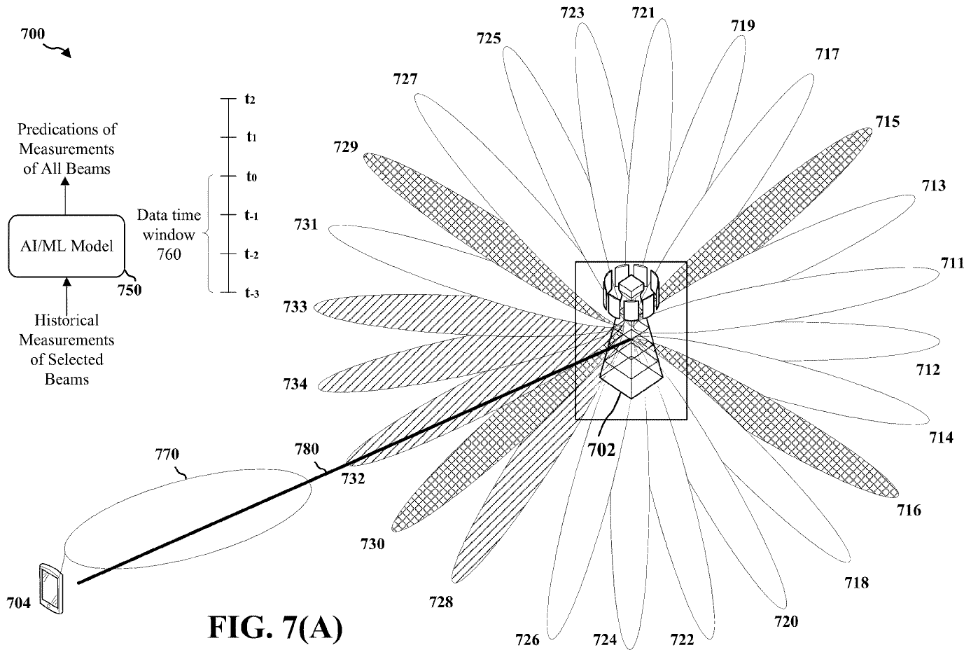

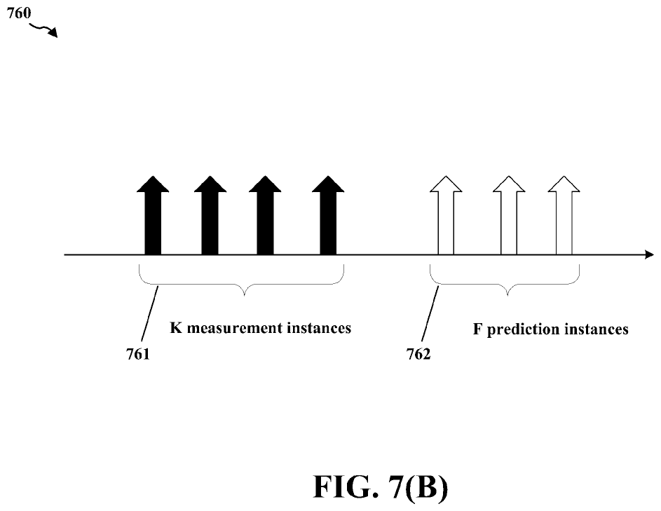

FIG. 7(A) is a diagram 700 illustrating an AI/ML (artificial intelligence/machine learning) model for spatial and temporal domain beam prediction. In this example, the base station 702 simultaneously transmits beams 711-734 in various directions via channel 780. After identifying incoming beams, the UE 704 can compute Layer 1 Reference Signal Received Power (L1-RSRP) for each beam. L1-RSRP is the average received power of the resource elements that carry the secondary synchronization signals or channel state information reference signals (CSI-RS).

Machine learning algorithms are used to analyze the history of signal strengths from a subset of beams and attempt to find patterns or trends in the data. This helps predict the signal strengths of the remaining unmeasured beams. By identifying patterns in historical data from the subset of beams, the algorithm can predict signal strengths of the other beams even as the UE is moving.

In this example, the base station 702 is equipped with multiple antennas and is capable of simultaneously radiating 24 different beams 711-734 in various directions. The UE 704, which moves from time to time, may be equipped with its own antenna and periodically measures channel indicators such as RSRP from 4 beams (e.g. beams 715, 716, 729, and 730) selected from the 24 beams radiated by the base station 702. The set of beams (e.g. beams 715, 716, 729, and 730) measured as AI/ML input (sensing beams) is referred to as beam Set B. The set of beams (e.g. the 24 beams) that is being predicted as AI/ML output (usually communication beams) is referred to as beam Set A.

The measurements collected from these 4 beams are saved over time as historical data. The historical data captures how the channel indicators for the subset of beams change over time, capturing how the UE 704 interacts with those beams. The UE 704 may be configured with a historical data time window 760 during which measurements are stored in the UE 704. In this example, the current time is to. The historical data time window 760 spans from time t₋₃ to t₀. Measurement data for the subset of beams 715, 716, 729, and 730 obtained during the historical data time window 760 are stored in the UE 704 and used as input to the AI/ML model 750 to predict measurements of unmeasured beams at the current time t₀ as well as measurements of all the beams at future times t₁, t₂.

The historical data serves as input to a machine learning algorithm to predict channel indicators for unmeasured beams, guiding the UE 704 on which beams to focus when it needs to communicate with the base station 702. The algorithm can thus predict channel indicators for all beams based on analyzing patterns and trends in the historical data from the subset of beams.

Another set of beams (e.g. beams 711, 721, 724, and 734) that are not normally measured under regular circumstances can be sampled periodically and their channel indicators recorded. This can be used to validate if the algorithm's predictions match actual performance while also updating the AI/ML model. Periodic measurements help improve the algorithm by updating its weights and parameters. As the machine learning algorithm matures, its predictions of the best beams will become increasingly accurate. When the UE 704 initiates communication, it can select the UE transmit or receive beam 770 that is likely to yield superior signal quality (e.g. the best beam) based on the prediction.

Rather than identifying a single best beam, the method predicts the top-k beams that are likely to have the highest channel indicators. In many cases, focusing on the top-k beams can provide excellent accuracy. The top-k beam prediction is achieved by estimating them based on the top-k channel indicator values. This aligns very well with real-world communication needs, improving system performance.

The main output of a classification-based AI/ML model includes identifiers (IDs) of the predicted top-k best beams for communication, along with corresponding predicted confidence scores or predicted RSRP for each beam. These beams are determined to be most suitable for communication based on expected signal strength and reliability. For example, if k is set to 5, the model might predict that the five best communication beams in the entire beam set are the beams numbered 732, 730, 734, 728, and 733. This prediction enables the UE 704 to make an informed decision on which beams the base station 702 and UE 704 should use to communicate at any given time, optimizing performance based on signal strength and likelihood of successfully transmitting data.

Furthermore, the output of a regression-based AI/ML model includes predicted RSRP values for each communication beam in beam Set A. This predicted output directly estimates the expected signal strength of each individual beam in the communication set, allowing the UE 704 to select beams more granularly based on the predicted RSRP values.

Beamforming, a technique for enhancing data rates and reliability in 5G and beyond wireless communication, especially in millimeter wave (mmWave) frequencies, enables a base station, such as the base station 702, to focus its signal transmission and reception toward a specific user equipment (UE), such as the UE 704. This targeted approach improves signal quality and reduces interference. To establish an optimal beam connection, the base station 702 and the UE 704 need to identify the best beams to transmit and receive data, a process known as beam management. Traditional beam management often involves exhaustive beam sweeping, where the base station 702 and the UE 704 systematically scan through all available beam directions to find the best one. However, this method becomes inefficient and resource-intensive as the number of antennas and beams increases, leading to significant overhead.

AI/ML-based beam management, in contrast, offers a more agile and efficient alternative to exhaustive beam sweeping. By using the power of machine learning, this approach predicts the optimal beams for communication based on analyzing patterns in historical data obtained from a subset of beams.

As illustrated in FIG. 7(A), rather than measuring all 24 beams, the UE 704 selectively measures the L1-RSRP from a smaller subset of beams, denoted as beam Set B, which serves as input to an AI/ML model 750. By analyzing patterns and trends in the historical data from this subset of beams, the AI/ML model 750 predicts the L1-RSRP values for the remaining unmeasured beams in beam Set A.

The AI/ML model 750 may take various forms, such as classification-based or regression-based models. A classification model predicts the top-k best beams for communication and provides associated confidence scores. A regression model directly estimates the RSRP values for each communication beam in beam Set A. Regardless of the chosen model, this predictive capability significantly reduces the need for exhaustive measurements, minimizing overhead and enhancing efficiency.

Temporal beam prediction, a key aspect of AI/ML-based beam management, predicts future optimal beam indices based on historical beam measurements. The UE 704 uses measurements taken over a historical data time window 760, allowing the model 750 to learn temporal patterns and anticipate future beam conditions.

In essence, AI/ML-based beam management provides a faster and more efficient way to obtain the best beam information, optimizing beam selection for communication between a base station and a UE, especially in dynamic environments where beam conditions may change rapidly.

As described supra, in a first scheme, a UE can report up to 4 beams in one UCI report using the CSI report format, as shown in Table 1. Each beam report includes two types of values: (1) the beam indicator, which is the beam ID (referred to as the RS resource ID in 3GPP), and (2) the corresponding RSRP value for each ID. The first reported RSRP may be the best RSRP measured by the UE, while the remaining reported RSRPs may be the differential values relative to the best RSRP.

TABLE 1
Beam Report Format

| CSI report number | CSI fields |
|---|---|
| CSI report #n | CRI or SSBRI # 1, if reported |
| | CRI or SSBRI # 2, if reported |
| | CRI or SSBRI # 3, if reported |
| | CRI or SSBRI # 4, if reported |
| | RSRP #1, if reported |
| | Differential RSRP #2, if reported |
| | Differential RSRP #3, if reported |
| | Differential RSRP #4, if reported |

However, to support beam reporting for AI/ML-based beam management, the beam report in the first scheme may have several drawbacks:

The current beam reporting cannot be used when the UE needs to report measurements for more than 4 beams to the network.

The current beam reporting cannot include time information, which may be required for beam measurement reporting in temporal beam prediction.

The current beam reporting mechanism requires the network to preconfigure the number of beams included in the configured beam report, while AI/ML-based beam reporting can benefit from the UE determining how many beams to report.

Considering these limitations, especially for AI/ML-based beam management, a new beam reporting format according to a second scheme may be used. This new format should address the following requirements while minimizing the UCI report overhead:

If the AI/ML model is located at the network side, the UE needs to report the measurements of beam Set B. Depending on the AI/ML model design, the suitable methods for reporting beam Set B measurements may differ. For temporal beam prediction, the UE may need to attach the corresponding time information (to indicate the measurement time) in the report.

If the AI/ML model is located at the UE side, the UE needs to report the inferred best beams among the communication beams. The UE may report a variable number of predicted best beams (according to the AI/ML model output design), which is not known beforehand by the network. In this case, a new reporting format for the measurements is required. For temporal beam prediction, the corresponding time information (to indicate the measurement time) might need to be attached in the report.

For data collection at the network side, the UE needs to report the measurements of a set of beams configured by the network. The UE may report a variable number of measured best beams as labels (according to the AI/ML model output design), which needs to be configured by the network. The UE may also report a variable number of measured beams (according to the AI/ML model input design), which might or might not be known beforehand by the network.

For model monitoring at either the UE side or the network side, the UE needs to report values that include at least the measurements of a set of beams configured by the network for model monitoring.

If the beam report format according to the first scheme is used, it may create a large UCI report overhead, especially when the number of reported beams is greater than 4, for data collection and model inference at the network side. Therefore, a new CSI report format is needed to accommodate the above cases while minimizing the UCI report overhead.

FIG. 7(B) is a diagram 760 illustrating the temporal aspects of beam measurement and prediction in AI/ML-based beam management. The figure shows two sequences: a measurement sequence 761 and a prediction sequence 762.

The measurement sequence 761 represents K measurement instances, where the UE 704 conducts beam measurements. These measurements are typically performed on a subset of beams (e.g., beam Set B), which serves as input to the AI/ML model. These measurements provide the power measurements of the sensing beams, which are used to infer the optimal communication beams.

The prediction sequence 762 represents F prediction instances, where the AI/ML model predicts the future optimal beam indices. These predictions are based on the beam measurements from the previous time steps, specifically the measurements taken during the K measurement instances.

This temporal structure aligns with the concept of temporal beam prediction, where the goal is to predict future optimal beam indices using the beam measurements on the sensing beams from previous time steps. The RSRP of one or more beams can be predicted with an input of historical RSRPs.

That is, the measurement sequence 761 corresponds to the time instances for which the UE 704 reports actual measurements. The prediction sequence 762 represents the future time instances for which the AI/ML model (either at the UE 704 or the base station 702) predicts beam conditions.

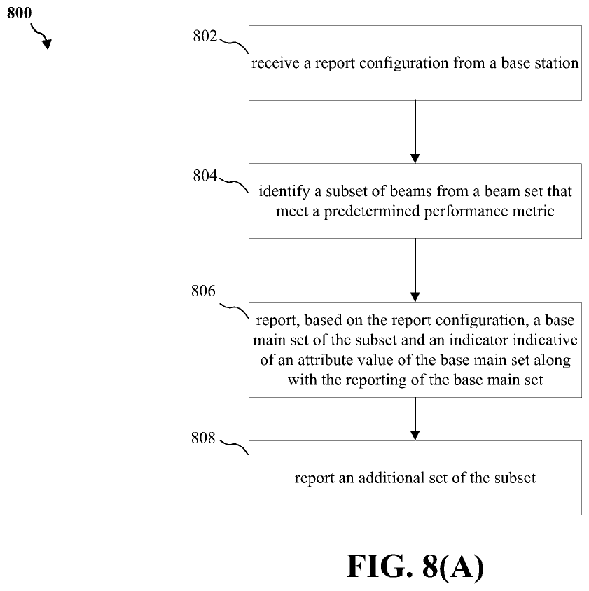

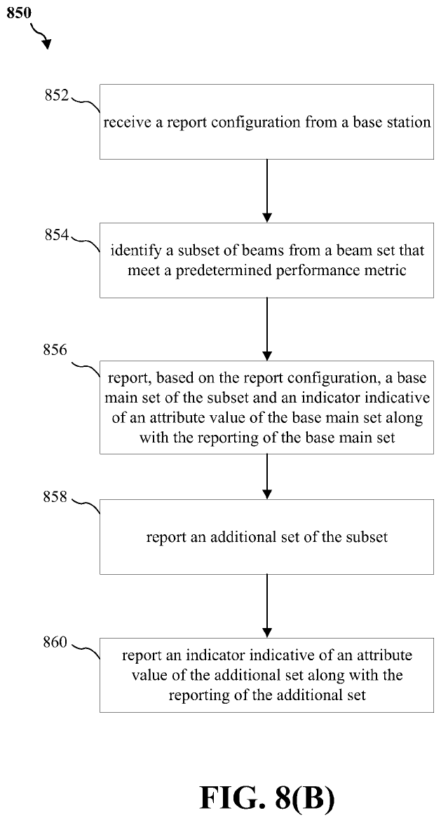

FIG. 8(A) is a flow chart 800 of a process for beam reporting. In this example, at block 802, the UE 704 receives a report configuration from a base station, such as the base station 702. The report configuration may include various parameters and instructions related to beam reporting, such as the number of beams to report, the type of measurements to include, and the reporting format.

At block 804, the UE 704 identifies a subset of beams from a beam set that meet a predetermined performance metric. The beam set may include all the beams, such as the 24 beams 711-734, that the base station 702 is capable of radiating. The performance metric may be, for example, sufficient signal strength and reliability. The UE 704 may identify the subset of beams, for example, based on measurements taken by the UE 704 and/or artificial intelligence/machine learning (AI/ML) model inference based on beam Set B.

At block 806, the UE 704 reports, based on the report configuration, a base main set of the subset and an indicator indicative of an attribute value of the base main set along with the reporting of the base main set. The base main set is a portion of the subset identified at block 804. Typically, the base main set follows the network's report configuration, reporting the beam indices and corresponding RSRPs of a number of beams conforming to the report configuration. For example, the base main set may include the beam index and the corresponding RSRP of the best beam in the subset. The attribute value may be any suitable information about the base main set and/or the additional set which will be further detailed in block 808 below. For example, the attribute value may indicate the time information associated with beam measurements included in the base main set.

At block 808, the UE 704 reports an additional set of the subset. The additional set is the remaining portion of the subset that is not included in the base main set. The additional set may include beam indices and/or corresponding RSRPs of a number of beams conforming to the report configuration. For example, if the base main set includes only the best beam, the additional set may include the second best beam, the third best beam, and so on.

FIG. 8(B) is a flow chart 850 of another process for beam reporting. In this example, blocks 852, 854, and 856 of the process 850 are similar to blocks 802, 804, and 806, respectively, of the process 800.

Further, at block 858, the UE 704 reports the additional set of the subset. At block 860, the UE 704 reports an indicator indicative of an attribute value of the additional set along with the reporting of the additional set. The attribute value may be any suitable information about the additional set. For example, the attribute value may indicate the time information associated with beam measurements included in the additional set.

As described above, the UE 704 can determine a subset (Set C) that meets the performance metrics (e.g. sufficient signal strength and reliability) from a beam set by utilizing measurements and/or AI/ML model inference (from Set B). However, the number of beams in Set C may exceed the report configuration pre-set by the NW. In some embodiments of the present disclosure, the method 800 separates Set C into the base main set and the additional set to report separately. The base main set typically follows the NW's report configuration. The additional set is the portion other than the base main set. In some embodiments of the present disclosure, the additional set includes a base subset, an additional main set, and an additional subset. The base subset has the same time information as the base main set. The additional main set has different time information from the base main set. The additional subset has the same time information as the additional main set.

As described above, the UE 704 can determine Set C by utilizing measurements and/or AI/ML model inference. The beam measurement can be conducted at multiple measurement time instances. For example, the UE 704 can conduct beam measurements in K measurement instances in a measurement sequence 761. The UE 704 can also utilize an AI/ML model to predict beam measurement values in F prediction instances in a prediction sequence 762. If the UE's beam report to the NW for all time instances are considered as a whole, it can be understood that each beam in the beam subset determined (through measurement and/or prediction) that meets the performance metrics may be obtained in the same measurement or prediction, or it may be obtained in different measurements or predictions.

This disclosure uses the terms “base main set”, “additional set”, “base subset”, “additional main set”, and “additional subset” to describe the different combinations of these beams. These terms are not intended to limit the importance of the beam combinations they describe, but merely serve as a distinction between different combinations of these beams. This disclosure sometimes also describes different combinations of these beams indistinguishably with the term “part”.

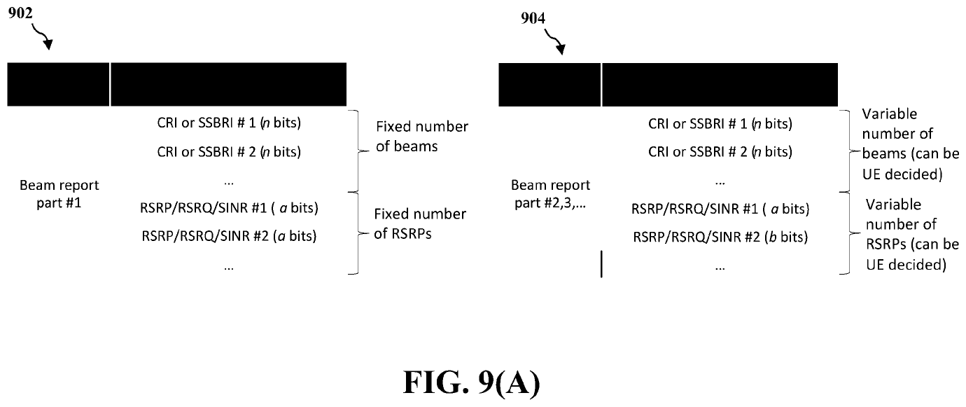

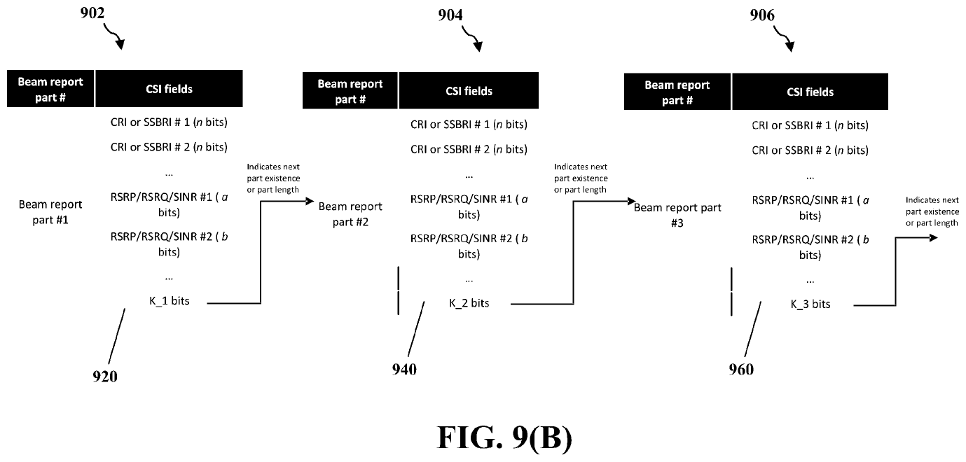

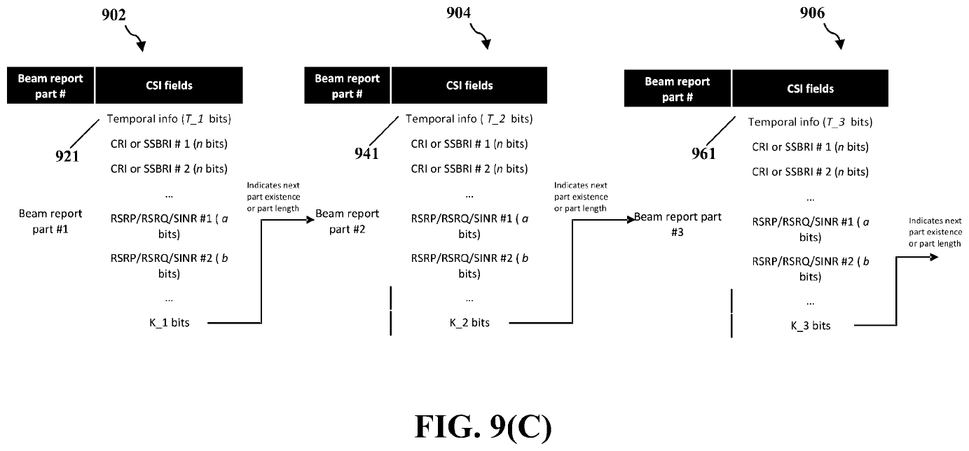

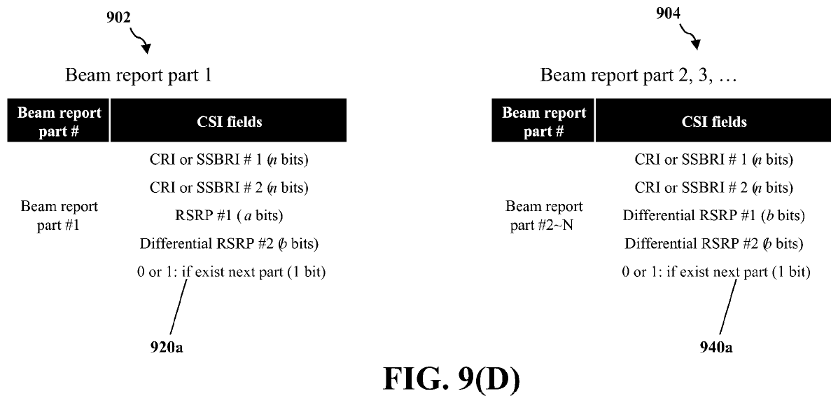

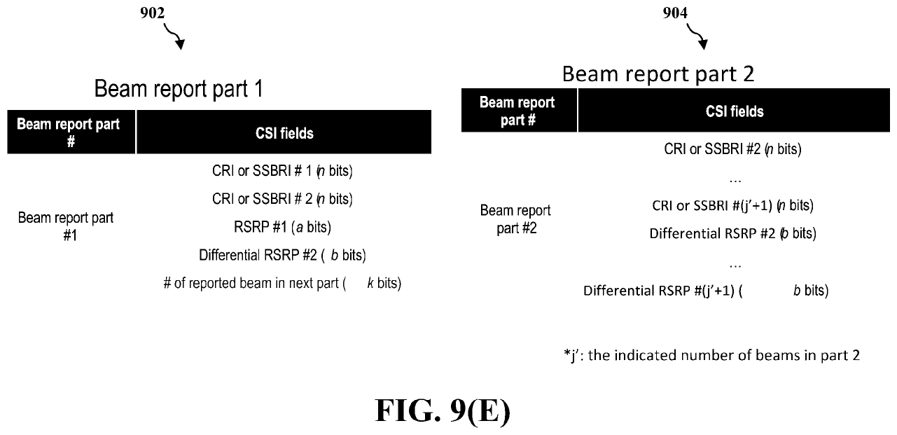

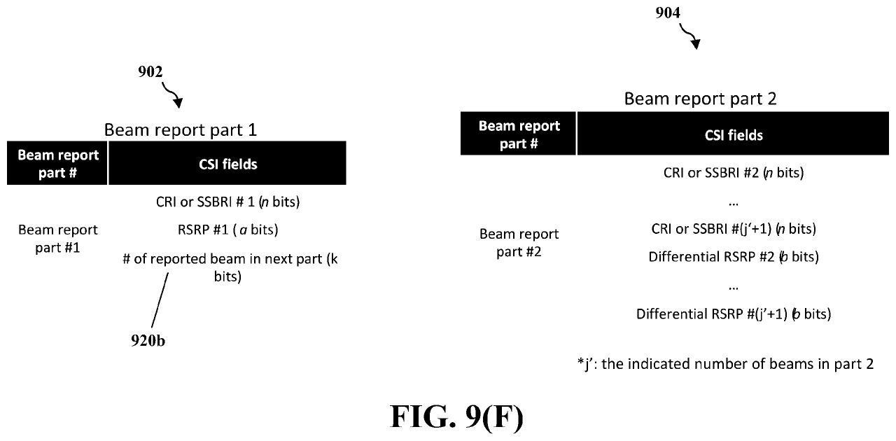

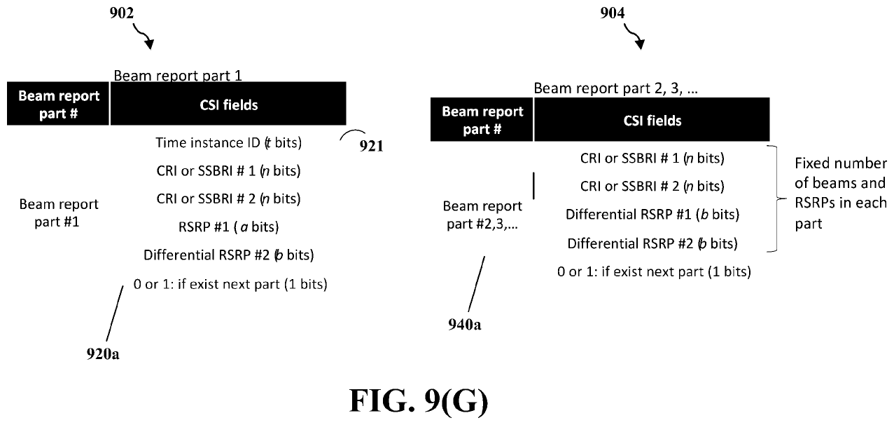

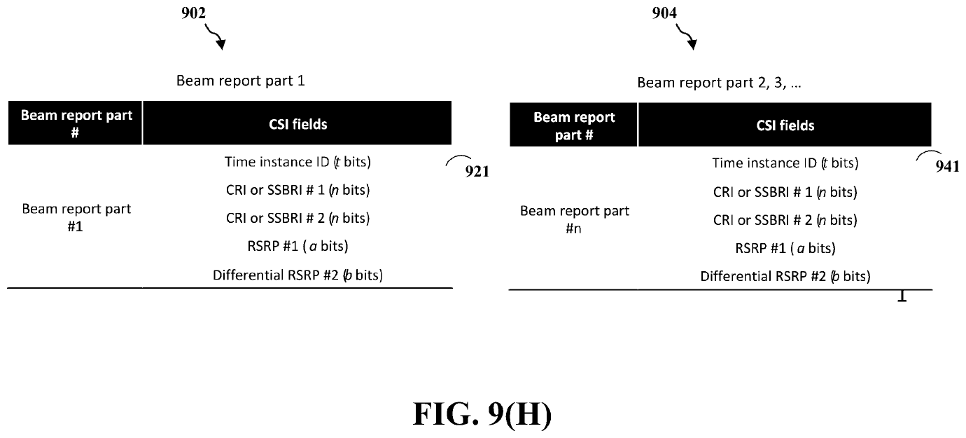

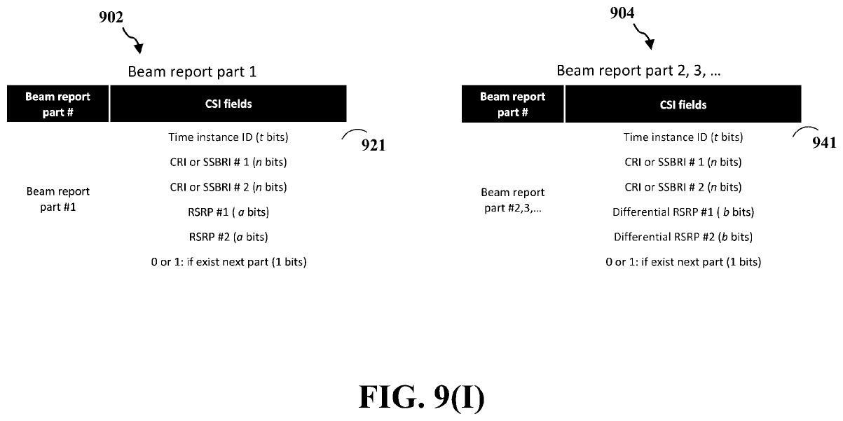

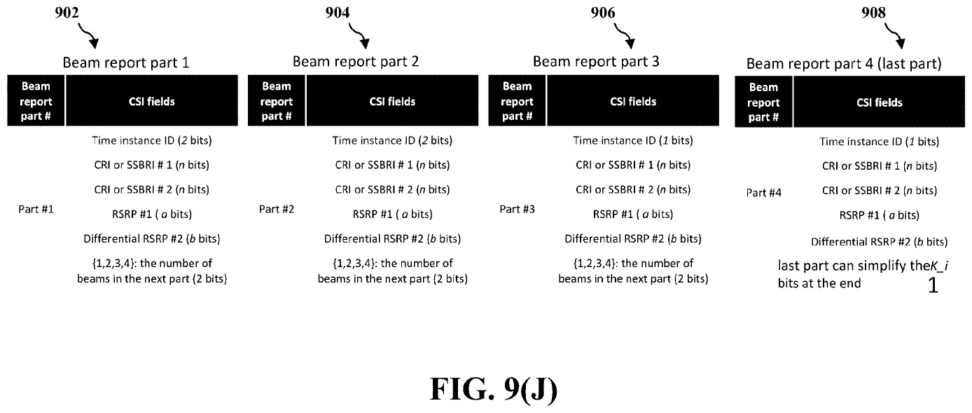

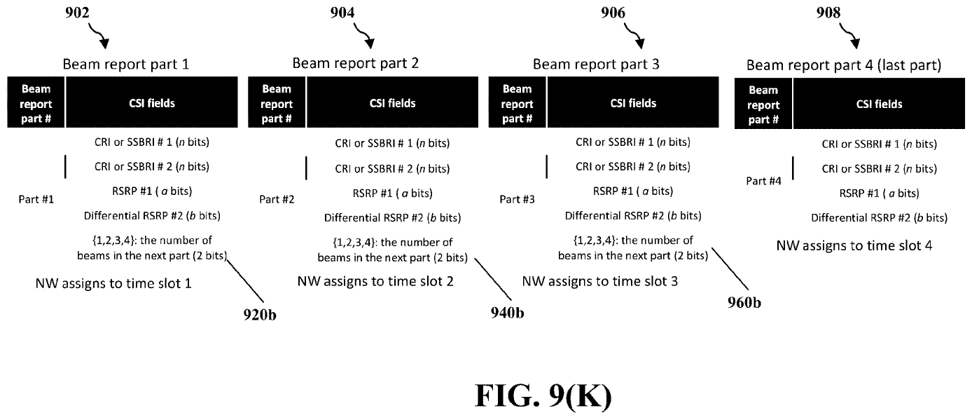

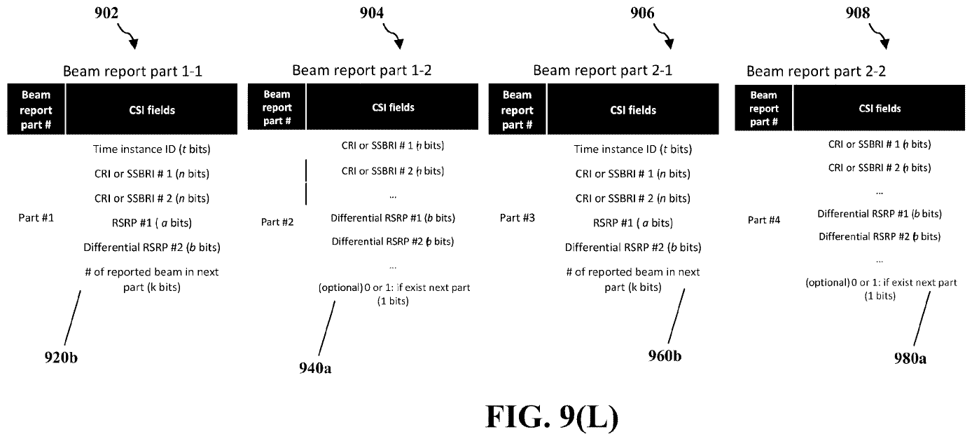

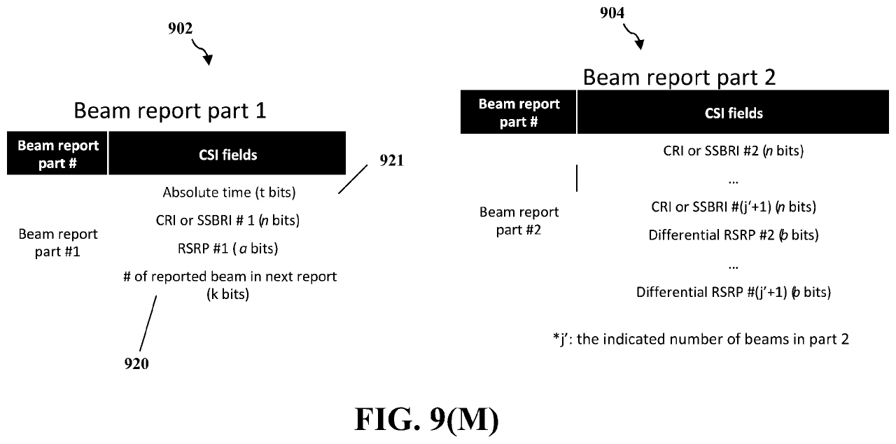

FIG. 9(A) is a diagram illustrating an example of separating a beam report into multiple parts according to the present disclosure. The UE 704's beam report to the base station 702 for all time instances can be divided into two or more parts, such as a first part 902 and a second part 904 shown in FIG. 9(A). The first part 902 has a fixed number of beams in the report (which may include signal measurements and/or signal resource indicators), where the number of beams and the reported content are pre-determined by the base station 702 (report configuration). The second part 904, on the other hand, has a variable number of beams in the report, where the number of beams and content are not consistent (i.e., they can be determined by the UE 704 and may differ for different reporting instances). It can be understood that the first part 902 corresponds to the base main set, while the second part 904 corresponds to the additional set.

As shown in FIG. 9(A), the base main set 902 and the additional set 904 typically include beam numbers and corresponding RSRPs for each beam. The beam numbers can be indicated using a Channel Resource Indicator (CRI) or a Synchronization Signal Block Resource Indicator (SSBRI) (n bits). The corresponding RSRP for each beam can be an absolute RSRP, which is the actual value of a beam's RSRP containing the complete bits of that RSRP (e.g., a bits as shown in FIG. 9(A)). Alternatively, it can be a relative RSRP, which is the difference between the absolute RSRP of one beam and the absolute RSRP of another beam (the reference beam) (e.g., b bits as shown in FIG. 9(A)). This is also referred to as differential RSRP in this disclosure (see below). The b bits are usually smaller than the a bits. By reporting the differential RSRP instead of the absolute RSRP, the number of bits required for reporting can be reduced. It should be understood that, except for the necessary reference beam that needs to report the absolute RSRP, other beams can report either the absolute RSRP or the differential RSRP.

FIG. 9(B) is a diagram illustrating an example of reporting indicators along with the base main set and additional sets according to the present disclosure. In some embodiments, referring to FIG. 9(B), an indicator 920 indicative of an attribute value of the base main set 902 can be reported along with the reporting of the base main set 902. Similarly, indicators 940 and 960 indicative of attribute values of the additional sets 904 and 906, respectively, can be reported along with the reporting of the additional sets. The term “attribute value” is used in this disclosure to describe certain information about the base main set or an additional set, which may include at least one of: 1) time information of the base main set or the additional set, 2) an existence flag of the additional set (for an additional set, it refers to another additional set), and 3) a length of the additional set (for an additional set, it refers to another additional set). It can be understood that the time information of the base main set or the additional set describes the time attribute value of the base main set or the additional set, i.e., from which measurement time instance in the measurement time sequence 761 in FIG. 7(B) the beams in the base main set or the additional set are obtained by measurement, or from which prediction time instance in the prediction time sequence 762 in FIG. 7(B) they are obtained by prediction. The existence flag and length of the additional set describe the association attribute value of the base main set or the additional set (i.e., the beam report of other parts is associated).

It should be understood that in this disclosure, the term “part” is sometimes also used to describe the entirety of the base main set or the additional set and the indicator indicative of the attribute value of the base main set or the additional set. From this perspective, a part may include the main bits representing the base main set or the additional set (including the reported beam numbers and the corresponding RSRPs of each beam), as well as the additional bits representing the indicator. From this holistic perspective, a beam report part can also be referred to as a base main set part or an additional set part.

Additional Kᵢ bits can be used in each part i (part number, i=1, 2, . . . ) to indicate the length/existence of its next part. These Kᵢ bits, such as the indicators 920, 940, and 960 shown in FIG. 9(B), can be used to indicate the length of the next part (number of beams to be reported or number of bits) or to indicate whether there is a next part (the length of the next part can be known by the base station 702 through separate signaling from the UE 704 to the base station 702). The value of Kᵢ can be decided and aligned between the base station 702 and the UE 704 using separate signaling, such as an RRC report configuration and/or a UE capability report. Additionally, if the number of parts is aligned between the base station 702 and the UE 704, the last part may not need to contain these additional Kᵢ bits. In other words, for the last additional set, it may not include an indicator.

Signaling transmission between the base station 702 and the UE 704 typically occurs in the MAC layer or the RRC layer. When the UE 704 reports beam information, signaling transmission can be performed through the MAC layer or the RRC layer. For example, if the signal is processed in the MAC layer, it can usually be transmitted through the Physical Uplink Shared Channel (PUSCH); if the signal is processed in the RRC layer, it can be transmitted through the Physical Uplink Control Channel (PUCCH).

In some embodiments of the present disclosure, the beam information is reported in multiple parts. For the first part, i.e., the base main set, it can be transmitted through the PUCCH, while for the remaining parts, i.e., the additional sets, they can be transmitted through the PUSCH. This transmission strategy uses different channels for different parts, and the channel selection can be based on factors such as the importance and data volume of different parts to optimize resource utilization and transmission efficiency.

FIG. 9(B) shows that the indicators 920, 940, and 960 indicate the association attribute values of the base main set or the additional set, i.e., the length/existence of the next part (additional set or another additional set).

As such, in the AI/ML-based beam management, the UE 704 can report beam measurements to the base station 702 in a new beam reporting format according to the second scheme. This new format aims to address the limitations of the beam report in the first scheme, and to accommodate the requirements of AI/ML-based beam management while minimizing the UCI report overhead.

As described supra, one feature of the new beam reporting format is the separation of the beam report into multiple parts. The first part, referred to as the base main set, has a fixed number of beams in the report, which can include the signal measurement and/or signal resource indicator. The number of beams and the reported content in the base main set are pre-determined by the base station 702 through the report configuration. The other parts, referred to as the additional sets, have a variable number of beams in the report, where the number of beams and content are not consistent. In other words, the number of beams and content in the additional sets can be determined by the UE 704 and can be different for different reporting instances.

To indicate the length or existence of the next part (i.e., the additional set or another additional set), additional Kᵢ bits are used in each part i, where i is the part number (i=1, 2, . . . ). These Kᵢ bits can be used in two ways, depending on the embodiment. In one embodiment, the Kᵢ bits indicate the length of the next part, which can be the number of beams to be reported or the number of bits in the next part. In another embodiment, the Kᵢ bits indicate whether there is a next part, and the length of the next part can be known by the base station 702 through separate signaling from the UE 704 to the base station 702 or predetermined by the base station 702 through the report configuration.

The value of K_{f} is decided and aligned between the base station 702 and the UE 704 by using separate signaling, such as an RRC report configuration and/or a UE capability report. Furthermore, if the number of parts is aligned between the base station 702 and the UE 704, the last part (i.e., the last additional set) does not necessarily need to contain these additional K₁ bits.

This new beam reporting format allows the UE 704 to report a variable number of beams to the base station 702, which is essential for AI/ML-based beam management. By separating the beam report into a base main set with a fixed number of beams and additional sets with a variable number of beams, the format provides flexibility in reporting while maintaining compatibility with the base station's report configuration. The use of Kᵢ bits to indicate the length or existence of the next part enables the UE 704 to communicate the structure of the beam report to the base station 702 efficiently.

FIG. 9(C) is a diagram illustrating an example of reporting time information along with the base main set and additional sets according to the present disclosure. In some embodiments of the present disclosure, referring to FIG. 9(C), additional Tᵢ bits can be used in each part i to indicate the temporal information (if reported) corresponding to the measurements or predictions reported in this part. The temporal information is any information that can be used to distinguish measurements and/or predictions by their corresponding time domain label. For example, the temporal information can be the absolute time when the measurement takes place (such as the corresponding slot of each measurement time instance in the measurement time sequence 761 in FIG. 7(B)), the index of each measurement time instance in the measurement sequence 761 (such as the first measurement, the second measurement, etc.), or the index of predicted best beams for each time instance in the prediction time sequence 762.

Furthermore, as shown in FIG. 9(C), in addition to the indicators 921, 941, and 961 describing the time attribute values of the base main set or the additional set, the indicators 920, 940, and 960 describing the association attribute values of the base main set or the additional set can still exist. This allows both the time information and the existence or length of the next part to be indicated in a single part.

The inclusion of temporal information in the beam report is particularly relevant for temporal beam prediction in AI/ML-based beam management. In temporal beam prediction, the UE 704 used measurements taken over a historical data time window 760 (as shown in FIG. 7(A)), allowing the AI/ML model 750 to learn temporal patterns and anticipate future beam conditions. The UE 704 may be configured to report measurements for multiple time instances within the observation window. By attaching the corresponding time information to each part of the beam report, the UE 704 can effectively communicate the temporal context of the reported measurements to the base station 702.

The use of Tᵢ bits to represent temporal information offers flexibility in reporting. The number of bits required for Tᵢ can vary depending on the specific embodiment and the granularity of temporal information needed. For example, if the UE 704 reports measurements for a large number of time instances, more bits may be required to uniquely identify each time instance. Conversely, if the number of time instances is small or if a coarser granularity is sufficient, fewer bits can be used.

The value of Tᵢ can be decided and aligned between the base station 702 and the UE 704 using separate signaling, similar to the Kᵢ bits used for indicating the length or existence of the next part. This separate signaling can be an RRC report configuration and/or a UE capability report.

FIG. 9(D) is a diagram illustrating an example of using K bits to indicate the existence of the next part according to the present disclosure. In some embodiments, referring to FIG. 9(D), K bits (where K=1) can be used to indicate whether the next part exists. Specifically, along with the reporting of the base main set 902, an indicator 920a can be used to indicate whether the next part exists, i.e., whether an additional set exists. Similarly, along with the reporting of the additional set 904, an indicator 940a can be used to indicate whether the next part exists, i.e., whether another additional set exists. Moreover, the length of each part may be known by the base station 702 through separate signaling from the UE 704 to the base station 702 or predetermined (e.g., determined by the base station 702 through the report configuration).

The base station 702 can indicate the UE 704 to perform a beam report, where the UE 704 can determine how many beams to report in an L1-RSRP report. When the UE 704 reports, it can use a 1-bit indicator (“0” or “1”) to indicate whether the next part exists. This indicator is reported along with the reporting of the base main set or the additional set.

In the example shown in FIG. 9(D), the beam report (denoted as #1-N, where N is the number of the last beam report part, and its value can be 2, 3, . . . ) may include:
Part 1 (base main set part): best CRI/SSBRI (n bits)+(absolute) RSRP (a bits)+second best CRI/SSBRI (n bits)+differential RSRP (b bits)+1 bit to indicate whether Part 2 exists (indicator of the attribute value of the base main set);
Part 2 (additional set part): if Part 2 exists, it includes 2 CRI/SSBRI (n bits)+2 differential RSRP (b bits)+1 bit to indicate whether Part 3 exists (indicator of the attribute value of the additional set);
Part 3 (another additional set part): if Part 3 exists, it has the same format as Part 2; where the value of n in the n bits of CRI/SSBRI depends on the number of configured RS beams for measurement.

This approach allows the UE 704 to flexibly report a variable number of beams to the base station 702 based on its determination, while still conforming to the base station's report configuration for the base main set. By using a single bit as an indicator to signal the existence of the next part, the UE 704 can efficiently communicate the structure of the beam report to the base station 702 without introducing significant overhead.

It should be noted that the specific number of bits used for the indicator (K=1 in this example) can be adjusted based on the system design and requirements. The value of K can be decided and aligned between the base station 702 and the UE 704 using separate signaling, such as an RRC report configuration and/or a UE capability report.

Furthermore, the format of each part in the beam report, including the number of CRI/SSBRI and RSRP values, as well as the use of absolute or differential RSRP, can be adapted according to the specific embodiment and the base station's configuration. The example provided in FIG. 9(D) serves as an illustration of the general principle of using K bits to indicate the existence of the next part in the beam report.

FIG. 9(E) is a diagram illustrating an example of using K bits to indicate the length of the next part according to the present disclosure. In some embodiments, referring to FIG. 9(E), K bits can be used to indicate the length of the next part. Specifically, along with the reporting of the base main set 902, an indicator 920b can be used to indicate the length (number of reported beams or number of bits) of the next part (additional set 904).

In the example shown in FIG. 9(E), the base station 702 indicates to the UE 704 to perform a two-part beam report, where the first part (base main set 902) has a fixed number of beams (in this example, 2) and the second part (additional set 904) has a variable number of beams. The base station 702 further indicates the value of j, which represents the maximum possible number of beams that will be included in Part 2. When the UE 704 reports, it reports information of 2 beams in the first part and uses k bits to indicate how many beams are reported in Part 2.

The two-part beam report format can be described as follows:
Part 1 (base main set 902): best CRI/SSBRI (n bits)+RSRP (a bits)+second best CRI/SSBRI (n bits)+Differential RSRP (b bits)+k bits to indicate how many beams are reported in Part 2 (indicator of the attribute value of the base main set);
Part 2 (additional set 904): CRI/SSBRI (n bits)+Differential RSRP (b bits) for the corresponding number of beams;

In this format, the number of bits n for CRI/SSBRI depends on the number of configured RS beams for measurement. The k bits used to indicate the number of beams in Part 2 are calculated as k=log₂(j), where j is the maximum possible number of beams that will be included in Part 2.

For example, if the maximum possible number of beams in Part 2 is j=4, then k=2. This means that two bits are used to indicate the number of beams in Part 2. In Part 2, j′ is the beam number index, which takes values from 1, 2, . . . , j. In the case where j=4, we can see that the beam numbers in Part 2 are 2, . . . , 5 (=j′+1, where j′=j).

This approach allows for flexible reporting of a variable number of beams in Part 2 while maintaining a fixed structure in Part 1. By using k bits to indicate the number of beams in Part 2, the UE 704 can efficiently communicate the structure of the beam report to the base station 702. This is particularly useful in AI/ML-based beam management scenarios where the number of beams to be reported may vary based on the AI/ML model's output or the current channel conditions.

The use of differential RSRP in both parts of the report helps to reduce the overall number of bits required for reporting. As mentioned earlier, differential RSRP uses fewer bits than absolute RSRP, as it represents the difference between the RSRP of the reported beam and a reference beam (typically the best beam reported in Part 1).

It is important to note that while this example describes a two-part beam report, the concept can be extended to include more parts if necessary. The same principle of using k bits to indicate the length of the next part can be applied recursively for additional parts, allowing for even more flexibility in beam reporting.

FIG. 9(F) is a diagram illustrating an example of using K bits to indicate the length of the next part with a shorter Part 1 according to the present disclosure. Similar to the example in FIG. 9(E), K bits can be used to indicate the length of the next part. Specifically, along with the reporting of the base main set 902, an indicator 920b can be used to indicate the length (number of reported beams or number of bits) of the next part (additional set 904).

In the example shown in FIG. 9(F), the base station 702 indicates to the UE 704 to perform a two-part beam report, where the first part (base main set 902) has a fixed number of beams and the second part (additional set 904) has a variable number of beams. Unlike the example in FIG. 9(E), the base main set 902 in this example contains information for only one beam. The base station 702 further indicates the value of j, which represents the maximum possible number of beams that will be included in Part 2. When the UE 704 reports, it reports information of 1 beam in the first part and uses k bits to indicate how many beams are reported in Part 2.

The two-part beam report format in this example can be described as follows:
Part 1 (base main set 902): best CRI/SSBRI (n bits)+RSRP (a bits)+k bits to indicate how many beams are included in Part 2 (indicator of the attribute value of the base main set);
Part 2 (additional set 904): CRI/SSBRI (in bits)+Differential RSRP (b bits) for the corresponding number of beams.

In this format, the number of bits n for CRI/SSBRI depends on the number of configured RS beams for measurement. The k bits used to indicate the number of beams in Part 2 are calculated as k=log₂(j), where j is the maximum possible number of beams that will be included in Part 2.

This embodiment demonstrates the flexibility of the beam reporting format. The base main set can be configured to report a smaller number of beams, in this case, just one beam instead of two as in the previous example. This flexibility allows for more efficient use of resources in scenarios where reporting a single best beam in the base main set is sufficient.

It is important to note that the number of beams reported in the base main set is typically set by the network's report configuration. The network usually configures the maximum number of beams to be reported, and the number of beams reported in the base main set can be less than or equal to this maximum value. This allows for adaptability in different network conditions and requirements.

The use of k bits to indicate the number of beams in Part 2 remains the same as in the previous example, maintaining the flexibility to report a variable number of beams in the additional set. This approach continues to support efficient communication of the beam report structure from the UE 704 to the base station 702.

Moreover, this format maintains the use of differential RSRP in Part 2, which helps to reduce the overall number of bits required for reporting. The differential RSRP represents the difference between the RSRP of the reported beam and the reference beam (in this case, the single beam reported in Part 1), allowing for efficient encoding of RSRP information.

FIG. 9(G) is a diagram illustrating an example of reporting temporal information along with the base main set and additional sets according to the present disclosure. In some embodiments, referring to FIG. 9(G), an indicator 921 indicative of the time attribute value of the base main set 902 can be reported along with the reporting of the base main set 902.

In these embodiments, the base station 702 configures a sequence of measurements for time instances in the observation window, such as the measurement time sequence 761 shown in FIG. 7(B). The base station 702 configures the UE 704 to separately report for each time instance, where the base station 702 further indicates that the UE 704 can determine how many beams to report in an L1-RSRP report.

When the UE 704 reports for each time instance, it reports temporal information only in part 1 of each beam report related to each time instance. This temporal information can be encoded as the ID of the corresponding time instance in the observation window.

The time instance ID can have t bits, where t represents the number of bits to represent the Time instance ID. The value of t depends on how many time instances are in the observation window. Specifically, t=log₂(number of time instances in the observation window). For example, referring to FIG. 7(B), when the number of time instances in the measurement time sequence 761 is 4 (K=4), t=2. In this case, the time instance ID has 2 bits (i.e., the IDs for time instances 1-4 are 00, 01, 10, 11 respectively).

Each beam report related to a time instance can include:
Part 1 (base main set 902): Time instance ID (t bits)+best CRI/SSBRI (n bits)+RSRP (a bits)+second best CRI/SSBRI (n bits)+Differential RSRP (b bits)+1 bit to indicate whether Part 2 exists (indicator 920a, which is an existence flag for the additional set);
Part 2 (additional set 904): If Part 2 exists, it includes: 2 CRI/SSBRI (n bits)+2 Differential RSRP (b bits)+1 bit to indicate whether Part 3 exists (indicator 940a, which is an existence flag for another additional set);
Part 3: If Part 3 exists, it has the same format as Part 2.

In the example shown in FIG. 9(G), the additional set 904 and the base main set 902 have the same temporal information. Therefore, the additional set 904 can omit reporting its temporal information. Unlike the indicators reported along with the base main set 902, which include both temporal information 921 and the existence flag 920a for the additional set, the indicator reported along with the additional set 904 may only include the existence flag 940a for another additional set. Since it has the same temporal information as the base main set 902, the additional set 904 can be more specifically referred to as a base subset.

This approach allows for efficient reporting of temporal information while maintaining flexibility in the number of beams reported. By including the temporal information only in the first part of each beam report, the UE 704 can provide the necessary time context for all measurements related to a specific time instance without unnecessary repetition in subsequent parts.

The use of time instance IDs with a variable number of bits (t) allows for efficient encoding of temporal information. This method adapts to the number of time instances in the observation window, using only as many bits as necessary to uniquely identify each time instance. This approach optimizes the use of bits in the beam report, reducing overhead while still providing accurate temporal context for the measurements.

The inclusion of existence flags (indicators 920a and 940a) in each part allows the UE 704 to flexibly report a variable number of beams for each time instance. This flexibility is beneficial for AI/ML-based beam management, where the number of significant beams may vary based on current channel conditions or the output of the AI/ML model.

Furthermore, this reporting structure supports the temporal beam prediction aspect of AI/ML-based beam management. By providing measurements for multiple time instances, each with its own temporal identifier, the UE 704 enables the base station 702 to track how beam conditions change over time. This temporal data can be used to train and refine AI/ML models for predicting future beam conditions, ultimately leading to more efficient beam management and improved communication performance.

The use of differential RSRP in Parts 2 and 3 (when they exist) helps to reduce the overall number of bits required for reporting. By reporting the difference in RSRP relative to the best beam reported in Part 1, the UE 704 can provide accurate signal strength information while using fewer bits than would be required to report absolute RSRP values for each beam.

This reporting structure aligns with the motivation described earlier to address the limitations of the beam report in the first scheme and accommodate the requirements of AI/ML-based beam management. It allows for reporting more than 4 beams when necessary, includes time information for temporal beam prediction, and allows the UE 704 to determine how many beams to report, all while minimizing the UCI report overhead.

FIG. 9(H) is a diagram illustrating an example of reporting multiple temporal information in one beam report according to the present disclosure. In some embodiments, referring to FIG. 9(H), indicators 921 and 941 indicative of the time attribute values of the base main set 902 and the additional set 904, respectively, can be reported along with the reporting of the base main set 902 and the additional set 904.

In these embodiments, the base station 702 configures a sequence of measurements for time instances in the observation window, such as the measurement time sequence 761 shown in FIG. 7(B). Unlike the example in FIG. 9(G), in the example of FIG. 9(H), the base station 702 configures the UE 704 to report once for the measurements of all the time instances, and further indicates that the UE 704 can report a fixed number of beams for each time instance.

When the UE 704 reports, it includes different temporal information in each part of the beam report. Similar to the example in FIG. 9(G), this temporal information is encoded as the ID of the corresponding time instance in the observation window, comprising t bits. Each part contains the corresponding measurements of the reported time instance ID, which includes:
Part 1 (base main set 902): Time instance ID (t bits)+best CRI/SSBRI (n bits)+RSRP (a bits)+second best CRI/SSBRI (n bits)+Differential RSRP (b bits);
Part 2 (additional set 904): If there is a Part 2, it includes: Time instance ID (t bits)+best CRI/SSBRI (n bits)+RSRP (a bits)+second best CRI/SSBRI (n bits)+Differential RSRP (b bits);
Part 3: If there is a Part 3, it has the same format as Part 2.

The time instance ID uses t bits, where t represents the number of bits required to represent the Time instance ID. The value of t depends on the number of time instances in the observation window. Specifically, t=log₂(number of time instances in the observation window). For example, if there are 8 time instances in the observation window, t would be 3, allowing for unique identification of each time instance.

In the example shown in FIG. 9(H), the additional set 904 and the base main set 902 have different temporal information, as indicated by the distinct indicators 921 and 941. The additional set 904 can be more specifically referred to as an additional main set, as it contains information for a different time instance than the base main set 902.

This approach allows for efficient reporting of measurements from multiple time instances in a single beam report. By including temporal information in each part, the UE 704 can provide comprehensive measurement data for multiple time instances to the base station 702 in one transmission. This is particularly useful for AI/ML-based beam management, where the base station 702 may need to analyze beam conditions across multiple time instances to make informed decisions or train prediction models.

The fixed number of beams reported for each time instance, as configured by the base station 702, provides a consistent structure to the beam report. This consistency can simplify processing at the base station 702 while still allowing for the reporting of measurements from multiple time instances.

The use of differential RSRP in the reporting structure helps to reduce the overall number of bits required for the beam report. By reporting the difference in RSRP relative to the best beam (reported with absolute RSRP), the UE 704 can provide accurate signal strength information for multiple beams while using fewer bits than would be required to report absolute RSRP values for each beam.

This reporting structure addresses several key requirements for AI/ML-based beam management. It allows for the reporting of measurements from multiple time instances, which is beneficial for temporal beam prediction. The inclusion of time instance IDs provides the necessary temporal context for each set of measurements. Furthermore, by allowing the UE 704 to report measurements for multiple time instances in a single beam report, this structure can potentially reduce the overall reporting overhead compared to sending separate reports for each time instance.

The flexibility of this reporting structure also allows for adaptation to various AI/ML model requirements. For example, if the AI/ML model requires input from a specific number of time instances, the base station 702 can configure the UE 704 to report measurements for exactly that number of instances. This alignment between the reporting structure and the AI/ML model input requirements can enhance the efficiency and effectiveness of the beam management process.

Moreover, this reporting structure supports both spatial and temporal aspects of beam management. The spatial aspect is addressed by reporting measurements for multiple beams at each time instance, while the temporal aspect is captured by including measurements from multiple time instances in a single report. This comprehensive approach provides the base station 702 with rich data for making informed decisions about beam selection and prediction.

In scenarios where the AI/ML model is implemented at the network side, this reporting structure allows the UE 704 to efficiently provide the necessary input data (measurements of beam Set B) to the base station 702. The inclusion of temporal information for each part of the report enables the base station 702 to accurately associate each set of measurements with its corresponding time instance, which is beneficial for temporal beam prediction algorithms.

Conversely, if the AI/ML model is implemented at the UE side, this reporting structure allows the UE 704 to report the inferred best beams among the communication beams for multiple time instances. The fixed number of beams reported for each time instance, as configured by the base station 702, can be aligned with the output of the AI/ML model, allowing for efficient reporting of the model's predictions.

FIG. 9(I) is a diagram illustrating an example of reporting multiple temporal information in one beam report with differential RSRP according to the present disclosure. In some embodiments, referring to FIG. 9(I), indicators 921 and 941 indicative of the time attribute values of the base main set 902 and the additional set 904, respectively, can be reported along with the reporting of the base main set 902 and the additional set 904. For the reporting of the additional set, differential RSRP values can be used. Similarly, for the reporting of the base main set, except for one reference beam, differential RSRP values can also be reported for other beams.

In these embodiments, the base station 702 configures the UE 704 to report once for the measurements of all time instances in the observation window, such as the measurement time sequence 761 shown in FIG. 7(B). The base station 702 further indicates that the UE 704 can report a fixed number of beams for each time instance and report differential RSRPs in beam report parts with part numbers greater than 1.

When the UE 704 reports, it includes different temporal information in each part of the beam report. Similar to the examples in FIG. 9(G) and FIG. 9(H), this temporal information is encoded as the ID of the corresponding time instance in the observation window, comprising t bits. Each part contains the corresponding measurements of the reported time instance ID.

As shown in FIG. 9(I), for the RSRP value corresponding to each beam, the UE 704 reports the absolute RSRP using a bits in the first part (base main set 902). In the remaining parts (additional sets 904), the UE 704 reports the differential RSRP using b bits. The differential RSRP is the difference between the reported RSRP and the RSRP in the first part that has the same order as the reported RSRP. For example, the Differential RSRP #m (b bits) in Beam report part #2 is the difference between the absolute RSRP of the CRI/SSBRI #m in Beam report part #2 and the RSRP #m in Beam report part #1.

This approach of reporting differential RSRP allows for a reduction in the number of bits used. For instance, if a equals 7 and b equals 4, using b bits instead of a bits saves 3 bits per RSRP report in the additional sets. This bit saving can reduce the overall size of the beam report, especially when reporting a large number of beams across multiple time instances.

Furthermore, similar to the example in FIG. 9(G), in addition to the indicator 921 indicating temporal information, the first part (base main set 902) may also include 1 bit (indicator 920a) to indicate whether a second part exists (existence flag for the additional set). The second part (additional set 904), in addition to the indicator 941 indicating temporal information, may also include 1 bit (indicator 940a) to indicate whether a next part exists (existence flag for another additional set). This pattern continues for subsequent parts until the last part, which may omit the indicator serving as an existence flag for the next additional set.

This reporting structure addresses several key requirements for AI/ML-based beam management while optimizing the use of bits in the beam report. By allowing the reporting of measurements from multiple time instances in a single beam report, it provides comprehensive temporal data that is useful for temporal beam prediction algorithms. The inclusion of time instance IDs for each part provides the necessary temporal context for each set of measurements.

The use of differential RSRP in parts beyond the first part significantly reduces the number of bits required for RSRP reporting. This is particularly beneficial when reporting measurements for multiple beams across multiple time instances, as it can substantially decrease the overall size of the beam report. The reduction in report size can lead to more efficient use of uplink resources and potentially allow for more frequent reporting, which could improve the accuracy and responsiveness of the beam management system.

The fixed number of beams reported for each time instance, as configured by the base station 702, provides a consistent structure to the beam report. This consistency can simplify processing at the base station 702 while still allowing for the reporting of measurements from multiple time instances. It also allows for alignment with the input requirements of various AI/ML models, whether they are implemented at the network side or the UE side.

The flexibility of this reporting structure supports both spatial and temporal aspects of beam management. The spatial aspect is addressed by reporting measurements for multiple beams at each time instance, while the temporal aspect is captured by including measurements from multiple time instances in a single report. This comprehensive approach provides the base station 702 with rich data for making informed decisions about beam selection and prediction.

In scenarios where the AI/ML model is implemented at the network side, this reporting structure allows the UE 704 to efficiently provide the necessary input data (measurements of beam Set B) to the base station 702. The inclusion of temporal information for each part of the report enables the base station 702 to accurately associate each set of measurements with its corresponding time instance.

Conversely, if the AI/ML model is implemented at the UE side, this reporting structure allows the UE 704 to report the inferred best beams among the communication beams for multiple time instances. The fixed number of beams reported for each time instance, as configured by the base station 702, can be aligned with the output of the AI/ML model, allowing for efficient reporting of the model's predictions.

The use of existence flags (indicators 920a and 940a) in each part allows for flexible reporting of a variable number of time instances. This flexibility is beneficial for adapting to varying channel conditions and AI/ML model requirements. It allows the UE 704 to report only as many time instances as necessary, potentially reducing the report size when fewer instances are sufficient.

FIG. 9(J) is a diagram illustrating an example of reporting multiple temporal information and variable beam numbers in one beam report according to the present disclosure. In this embodiment, the base station 702 configures a sequence of measurements for 4 time instances in the observation window. The base station 702 configures the UE 704 to report once for the measurements of all the time instances, where the base station 702 further indicates that the UE 704 can report a variable number of beams (in this example, maximum=4) for each time instance, while the part of the first-time instance has a fixed beam number of 2.

When the UE 704 reports, it places the measurement for each time slot into different beam report parts. The UE 704 also reports different temporal information in each part, with the temporal information encoded as follows:

The UE 704 uses Tᵢ bits to indicate the time instance ID (i.e., temporal information) of each part. The number of Tᵢ bits in each part can be reduced as the value of i for part i increases. Tᵢ can be determined by ┌log₂(remaining_time_slots_to_report)┐, where remaining_time_slots_to report is the same as the remaining parts, and Tᵢ bits can be used to represent the index of the reported time slot among the sequence of the remaining time slots that are going to be reported.

For example, in FIG. 9(J), the base station 702 configures a measurement sequence with 4 measurement time instances. Initially, remaining_time_slots_to report=4, so ┌log₂(4)┐=2, meaning the time instance ID has 2 bits, e.g., 00, 01, 10, 11. After the base main set 902 is reported, the remaining time slots become 3, but ┌log₂(3)┐ is still 2, so the time instance ID still has 2 bits for the additional set 904.

After both the base main set 902 and the additional set 904 are reported, the remaining time slots become 2. Now, remaining time_slots to report=2, so ┌log₂(2)┐=1, meaning the time instance ID can have only 1 bit. For the additional sets 906 and 908, their time instance IDs 961 and 981 could be 10 and 11 respectively. Since only two time slots remain, using only the lower bit “0” and “1” of their time instance IDs is sufficient to distinguish between them. Therefore, the identical higher bit “1” of their time instance IDs can be omitted, reporting only the different lower bit using 1 bit.

In each part, the UE 704 appends k bits (in this example, 2 bits because the maximum number of beams per part is configured by the base station 702 as 4) to indicate the number of beams reported in the next part. Specifically, except for the last part, each part includes indicators 920b, 940b, and 960b of the association attribute value, which indicate the number of beams (such as 1, 2, 3, or 4) reported in the next part.

This reporting structure allows for efficient encoding of temporal information while supporting variable beam reporting. By reducing the number of bits used for time instance IDs in later parts, it minimizes the overhead associated with temporal information. The use of k bits to indicate the number of beams in the next part provides flexibility in beam reporting, allowing the UE 704 to adapt to changing channel conditions and AI/ML model requirements.

It's important to note that while the example in FIG. 9(J) shows a specific order of reporting, in most cases, the reporting of different parts does not need to follow a specific order. The parts can be reported simultaneously or in any order. However, reporting in a specific order that prioritizes keeping the remaining IDs with fewer bit differences could potentially allow for more efficient bit reduction in ID reporting. For example, reporting IDs 00 and 01 before 10 and 11 allows for reducing the ID to a single bit in the later reports.

This reporting structure addresses several key requirements for AI/ML-based beam management. It allows for the reporting of measurements from multiple time instances. The inclusion of time instance IDs provides the necessary temporal context for each set of measurements. Furthermore, by allowing the UE 704 to report a variable number of beams for each time instance, this structure can adapt to varying channel conditions and AI/ML model outputs.

The use of a variable number of bits for time instance IDs and the inclusion of beam count indicators for subsequent parts provide a flexible and efficient reporting mechanism. This approach can significantly reduce the overall size of the beam report, especially when reporting measurements for multiple time instances, each with a potentially different number of significant beams.

In scenarios where the AI/ML model is implemented at the network side, this reporting structure allows the UE 704 to efficiently provide the necessary input data (measurements of beam Set B) to the base station 702. The inclusion of temporal information for each part of the report enables the base station 702 to accurately associate each set of measurements with its corresponding time instance, which is useful for temporal beam prediction algorithms.

Conversely, if the AI/ML model is implemented at the UE side, this reporting structure allows the UE 704 to report the inferred best beams among the communication beams for multiple time instances. The variable number of beams reported for each time instance can be aligned with the output of the AI/ML model, allowing for efficient reporting of the model's predictions.

This embodiment demonstrates how the beam reporting format can be optimized to accommodate both spatial and temporal aspects of beam management while minimizing the reporting overhead. By dynamically adjusting the number of bits used for temporal information and allowing for variable beam reporting, it provides a flexible and efficient solution for AI/ML-based beam management in advanced wireless communication systems.

FIG. 9(K) is a diagram illustrating an example of reporting multiple temporal information and variable beam numbers in one beam report with simplified temporal information according to the present disclosure. In this embodiment, the base station 702 configures a sequence of measurements for 4 time instances in the observation window. The base station 702 configures the UE 704 to report once for the measurements of all the time instances, where the base station 702 further indicates that the UE 704 can report a variable number of beams (in this example, maximum=4) for each time instance, while the part of the first-time instance has a fixed beam number of 2.

When the UE 704 reports, it places the measurement for each time slot into different beam report parts. Unlike the example in FIG. 9(J), in the example shown in FIG. 9(K), the UE 704 simplifies the temporal information by placing the measurement for each time slot into report parts following the order of time slot indices. This order is known to both the UE 704 and the base station 702, as this report is configured by the base station 702. This approach eliminates the need to explicitly include temporal information in every report part. Consequently, compared to the example in FIG. 9(J), the example in FIG. 9(K) does not include indicators of the time attribute value, resulting in a smaller overall size for the beam report.

In each part, the UE 704 appends k bits (in this example, 2 bits because the maximum number of beams per part is configured by the base station 702 as 4) to indicate the number of beams reported in the next part. Specifically, the base main set 902, the additional set 904, and the additional set 906 include indicators 920b, 940b, and 960b of the association attribute value, respectively. These indicators show the number of beams (such as 1, 2, 3, or 4) reported in the next part.

The beam report format in this example can be described as follows:
Part 1 (base main set 902): CRI or SSBRI #1 (n bits)+CRI or SSBRI #2 (n bits)+RSRP #1 (a bits)+Differential RSRP #2 (b bits)+2 bits to indicate the number of beams in the next part;
Part 2 (additional set 904): CRI or SSBRI #1 (n bits)+CRI or SSBRI #2 (n bits)+RSRP #1 (a bits)+Differential RSRP #2 (b bits)+2 bits to indicate the number of beams in the next part;
Part 3 (additional set 906): CRI or SSBRI #1 (n bits)+CRI or SSBRI #2 (n bits)+RSRP #1 (a bits)+Differential RSRP #2 (b bits)+2 bits to indicate the number of beams in the next part;
Part 4 (additional set 908): CRI or SSBRI #1 (n bits)+CRI or SSBRI #2 (n bits)+RSRP #1 (a bits)+Differential RSRP #2 (b bits).

When the base station 702 receives the report, it assigns the reported measurements to each time slot following the received part order in the report. Specifically, the base station 702 assigns the measurements in Part 1 to time slot 1, Part 2 to time slot 2, Part 3 to time slot 3, and Part 4 to time slot 4.

This reporting structure offers several advantages for AI/ML-based beam management. By eliminating the need to explicitly report temporal information in each part, it reduces the overall size of the beam report. This reduction in report size can lead to more efficient use of uplink resources, potentially allowing for more frequent reporting or the reporting of more beam measurements within the same resource constraints.

The flexibility of reporting a variable number of beams for each time instance, indicated by the 2-bit field at the end of each part (except the last part), allows the UE 704 to adapt its reporting to the current channel conditions and the output of the AI/ML model. For instance, if the AI/ML model predicts that only two beams are significant for a particular time instance, the UE 704 can report just those two beams, saving resources that would otherwise be used to report less significant beams.

Furthermore, this reporting structure supports both spatial and temporal aspects of beam management. The spatial aspect is addressed by reporting measurements for multiple beams at each time instance, while the temporal aspect is captured by including measurements from multiple time instances in a single report. This comprehensive approach provides the base station 702 with rich data for making informed decisions about beam selection and prediction.

In scenarios where the AI/ML model is implemented at the network side, this reporting structure allows the UE 704 to efficiently provide the necessary input data (measurements of beam Set B) to the base station 702. The implicit temporal ordering of the parts enables the base station 702 to accurately associate each set of measurements with its corresponding time instance, which is useful for temporal beam prediction algorithms.

Conversely, if the AI/ML model is implemented at the UE side, this reporting structure allows the UE 704 to report the inferred best beams among the communication beams for multiple time instances. The variable number of beams reported for each time instance can be aligned with the output of the AI/ML model, allowing for efficient reporting of the model's predictions.

The use of differential RSRP in the reporting structure helps to further reduce the overall number of bits required for the beam report. By reporting the difference in RSRP relative to the best beam (reported with absolute RSRP), the UE 704 can provide accurate signal strength information for multiple beams while using fewer bits than would be required to report absolute RSRP values for each beam.

This embodiment demonstrates how the beam reporting format can be optimized to accommodate both spatial and temporal aspects of beam management while minimizing the reporting overhead. By implicitly encoding temporal information through the order of report parts and allowing for variable beam reporting, it provides a flexible and efficient solution for AI/ML-based beam management in advanced wireless communication systems.

The use of differential RSRP in the reporting structure helps to further reduce the overall number of bits required for the beam report. By reporting the difference in RSRP relative to the best beam (reported with absolute RSRP), the UE 704 can provide accurate signal strength information for multiple beams while using fewer bits than would be required to report absolute RSRP values for each beam.

This embodiment demonstrates how the beam reporting format can be optimized to accommodate both spatial and temporal aspects of beam management while minimizing the reporting overhead. By implicitly encoding temporal information through the order of report parts and allowing for variable beam reporting, it provides a flexible and efficient solution for AI/ML-based beam management in advanced wireless communication systems.

FIG. 9(L) is a diagram illustrating an example of reporting multiple temporal information and variable beam numbers in one beam report using a two-part structure for each time instance according to the present disclosure. In this embodiment, the base station 702 configures a sequence of measurements for time instances in the observation window. The base station 702 configures the UE 704 to report once for the measurements of all the time instances, where the base station 702 further indicates that the UE 704 uses two-part reporting to report a variable number of beams for each time instance.

When the UE 704 reports, it uses two parts to report the measurement for each time instance. For each instance, the first part includes: (1) temporal information, (2) a fixed number of beams, and (3) k bits to indicate the number of beams in the second part. The second part includes: (1) a variable number of beams and (2) an optional binary indicator to indicate if there exists a next part.

The temporal information is represented by t bits, where t=log₂(number of time instances in the observation window). This allows for efficient encoding of the Time Instance ID, with the number of bits adapting to the total number of time instances to be reported.

In the example shown in FIG. 9(L), the beam report is divided into multiple parts, including a base main set 902 and additional sets 904-908. The additional sets can be more specifically referred to as a base subset 904, an additional main set 906, and an additional subset 908.

The base main set 902 and the base subset 904 share the same temporal information, which is reported via the indicator 921. After reporting the time ID 921 in the base main set 902, the temporal information for the base subset 904 can be omitted to reduce overhead. The indicator 920b, reported along with the base main set 902, indicates the number of beams included in the base subset 904. Optionally, an indicator 940a may be reported along with the base subset 904 to indicate whether a next part exists.

Similarly, the additional main set 906 and the additional subset 908 share the same temporal information, reported via the indicator 961. After reporting the time ID 961 in the additional main set 906, the temporal information for the additional subset 908 can be omitted. The indicator 960b, reported along with the additional main set 906, indicates the number of beams included in the additional subset 908. Optionally, an indicator 980a may be reported along with the additional subset 908 to indicate whether a next part exists.

This reporting structure allows for efficient encoding of both temporal and beam information. By using a two-part structure for each time instance, it provides flexibility in reporting a variable number of beams while maintaining a consistent format. The use of shared temporal information between main sets and their corresponding subsets reduces redundancy in the report.

The beam report parts in FIG. 9(L) typically include the following information:
Beam report part 1-1 (base main set 902): Time instance ID (t bits)+CRI or SSBRI #1 (n bits)+CRI or SSBRI #2 (n bits)+RSRP #1 (a bits)+Differential RSRP #2 (b bits)+Number of reported beams in next part (k bits);
Beam report part 1-2 (base subset 904): CRI or SSBRI #1 (n bits)+CRI or SSBRI #2 (n bits)+Differential RSRP #1 (b bits)+Differential RSRP #2 (b bits)+Optional 0 or 1 to indicate if next part exists (1 bit);
Beam report part 2-1 (additional main set 906): Time instance ID (t bits)+CRI or SSBRI #1 (n bits)+CRI or SSBRI #2 (n bits)+RSRP #1 (a bits)+Differential RSRP #2 (b bits)+Number of reported beams in next part (k bits);
Beam report part 2-2 (additional subset 908): CRI or SSBRI #1 (n bits)+CRI or SSBRI #2 (n bits)+Differential RSRP #1 (b bits)+Differential RSRP #2 (b bits)+Optional 0 or 1 to indicate if next part exists (1 bit).

This structure allows for efficient reporting of measurements from multiple time instances with variable numbers of beams. The use of differential RSRP in the subsets helps to reduce the overall number of bits required for the beam report. By reporting the difference in RSRP relative to the best beam (reported with absolute RSRP in the main sets), the UE 704 can provide accurate signal strength information for multiple beams while using fewer bits than would be required to report absolute RSRP values for each beam.

The flexibility of this reporting structure supports both spatial and temporal aspects of beam management. The spatial aspect is addressed by reporting measurements for multiple beams at each time instance, while the temporal aspect is captured by including measurements from multiple time instances in a single report. This comprehensive approach provides the base station 702 with rich data for making informed decisions about beam selection and prediction in AI/ML-based beam management systems.

Moreover, this reporting structure is particularly beneficial for AI/ML-based beam management scenarios. In cases where the AI/ML model is implemented at the network side, this structure allows the UE 704 to efficiently provide the necessary input data (measurements of beam Set B) to the base station 702. The inclusion of temporal information for each main set enables the base station 702 to accurately associate each set of measurements with its corresponding time instance, which is useful for temporal beam prediction algorithms.

Conversely, if the AI/ML model is implemented at the UE side, this reporting structure allows the UE 704 to report the inferred best beams among the communication beams for multiple time instances. The variable number of beams reported for each time instance can be aligned with the output of the AI/ML model, allowing for efficient reporting of the model's predictions.

This embodiment demonstrates how the beam reporting format can be optimized to accommodate both spatial and temporal aspects of beam management while minimizing the reporting overhead. By using a two-part structure for each time instance and allowing for variable beam reporting, it provides a flexible and efficient solution for AI/ML-based beam management in advanced wireless communication systems.

FIG. 9(M) is a diagram illustrating an example of reporting absolute time for each part in a beam report according to the present disclosure. This embodiment presents an alternative design to the embodiment described in FIG. 9(G), with the key difference being the use of absolute time instead of time instance ID for temporal information.

In this embodiment, the base station 702 configures a sequence of measurements for time instances in the observation window. The base station 702 configures the UE 704 to report separately for each time instance, where the base station 702 further indicates that the UE 704 can determine how many beams to report in an L1-RSRP report.

When the UE 704 reports for each time instance, it reports temporal information only in part 1 of each beam report. Unlike the example in FIG. 9(G) where the temporal information is encoded as the ID of the corresponding time instance in the observation window, in this embodiment, the temporal information is encoded as the absolute time when the measurement included in this report is taken.

The beam report is divided into two parts: a base main set 902 (Part 1) and an additional set 904 (Part 2). The content of these parts is as follows:
Part 1 (base main set 902): Absolute time (t bits)+best CRI/SSBRI (n bits)+RSRP (a bits)+k bits to indicate how many beams are included in Part 2;
Part 2 (additional set 904): CRI/SSBRI+Differential RSRP (b bits) for the corresponding number of beams; and
The k bits in Part 1 are calculated as k=log₂(j), where j is the maximum possible number of beams that will be included in Part 2.

The use of absolute time in this embodiment provides several advantages for AI/ML-based beam management. First, it allows for precise temporal alignment of measurements. The absolute time stamp provides a clear reference point for each measurement, enabling the base station 702 to accurately track the evolution of beam conditions over time.

Furthermore, the use of absolute time can simplify the processing of measurements at the base station 702. Instead of having to map time instance IDs to actual measurement times, the base station 702 can directly use the reported absolute times to associate measurements with specific moments in time. This can be particularly beneficial in scenarios where measurements might not be taken at perfectly regular intervals due to various system constraints.

The flexibility in the number of reported beams, indicated by the k bits in Part 1, allows the UE 704 to adapt its reporting to the current channel conditions and the requirements of the AI/ML model. If the AI/ML model determines that only a few beams are significant for a particular time instance, the UE 704 can report just those beams, saving uplink resources.

The use of differential RSRP in Part 2 helps to reduce the overall size of the beam report. By reporting the difference in RSRP relative to the best beam (reported with absolute RSRP in Part 1), the UE 704 can provide accurate signal strength information for multiple beams while using fewer bits than would be required to report absolute RSRP values for each beam.

This reporting structure supports both spatial and temporal aspects of beam management. The spatial aspect is addressed by reporting measurements for multiple beams, while the temporal aspect is captured by the absolute time stamp and the ability to send multiple reports for different time instances. This comprehensive approach provides the base station 702 with rich data for making informed decisions about beam selection and prediction.

In scenarios where the AI/ML model is implemented at the network side, this reporting structure allows the UE 704 to efficiently provide the necessary input data (measurements of beam Set B) to the base station 702. The inclusion of absolute time for each report enables the base station 702 to accurately associate each set of measurements with its corresponding time, which is useful for temporal beam prediction algorithms.

Conversely, if the AI/ML model is implemented at the UE side, this reporting structure allows the UE 704 to report the inferred best beams among the communication beams for multiple time instances. The variable number of beams reported for each time instance can be aligned with the output of the AI/ML model, allowing for efficient reporting of the model's predictions.

This embodiment demonstrates how the beam reporting format can be optimized to accommodate both spatial and temporal aspects of beam management while providing precise temporal information. By using absolute time and allowing for variable beam reporting, it provides a flexible and efficient solution for AI/ML-based beam management in advanced wireless communication systems.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving a report configuration from a base station;
identifying a subset of beams from a beam set that meet a predetermined performance metric;
reporting, based on the report configuration, a base main set of the subset and an indicator indicative of an attribute value of the base main set along with the reporting of the base main set; and
reporting an additional set of the subset.

2. The method of claim 1, wherein the attribute value of the base main set comprises at least one of: time information of the base main set, an existence flag of the additional set, and a length of the additional set.

3. The method of claim 2, wherein the time information of the base main set comprises an absolute time or a time identifier.

4. The method of claim 2, further comprising: reporting an indicator indicative of an attribute value of the additional set along with the reporting of the additional set.

5. The method of claim 4, wherein the attribute value of the additional set comprises at least one of: time information of the additional set, an existence flag of another additional set, and a length of the another additional set.

6. The method of claim 5, wherein the indicator reported along with the base main set comprises the time information of the base main set and the existence flag of the additional set, and the indicator reported along with the additional set comprises the existence flag of another additional set.

7. The method of claim 6, wherein the indicator reported along with the additional set further comprises the time information of the additional set.

8. The method of claim 5, wherein the indicator reported along with the base main set comprises the time information of the base main set and the length of the additional set, and the indicator reported along with the additional set comprises the time information of the additional set.

9. The method of claim 8, wherein the time information of the additional set is reported in a reduced form.

10. The method of claim 8, wherein the indicator reported along with the additional set further comprises the length of another additional set.

11. The method of claim 5, wherein the base main set and the additional set are reported in different slots, and the indicator reported along with the base main set comprises the length of the additional set.

12. The method of claim 11, wherein the indicator reported along with the additional set comprises the length of another additional set.

13. The method of claim 5, wherein the additional set comprises a base subset, an additional main set, and an additional subset, the base subset having the same time information as the base main set, the additional main set having different time information from the base main set, and the additional subset having the same time information as the additional main set;
wherein the indicator reported along with the base main set further comprises the length of the base subset; and
wherein the indicator reported along with the additional main set further comprises the length of the additional subset.

14. The method of claim 13, wherein the indicator reported along with the additional subset comprises an existence flag of another additional subset.

15. The method of claim 1, wherein reference signal received power (RSRP) for all beams in the additional set are differential RSRPs.

16. The method of claim 1, wherein the base main set and the additional set are reported based on time information that is not explicitly indicated by an indicator.

17. An apparatus for wireless communication, the apparatus being a user equipment (UE), comprising:
a memory; and
at least one processor coupled to the memory and configured to:
receive a report configuration from a base station;
identifying a subset of beams from a beam set that meet a predetermined performance metric;
report, based on the report configuration, a base main set of the subset and an indicator indicative of an attribute value of the base main set along with the reporting of the base main set; and
report an additional set of the subset.

18. The apparatus of claim 17, wherein the attribute value of the base main set comprises at least one of: time information of the base main set, an existence flag of the additional set, and a length of the additional set.

19. The apparatus of claim 17, wherein the at least one processor is further configured to report an indicator indicative of an attribute value of the additional set along with the reporting of the additional set.

20. A computer-readable medium storing computer executable code for wireless communication of a user equipment (UE), comprising code to:
receive a report configuration from a base station;
identifying a subset of beams from a beam set that meet a predetermined performance metric;
report, based on the report configuration, a base main set of the subset and an indicator indicative of an attribute value of the base main set along with the reporting of the base main set; and
report an additional set of the subset.
